(19) United States
(12) Patent Application Publication
(10) Pub. No.: US 2025/0149666 A1
(43) Pub. Date: May 8, 2025

(54) Secondary Battery Having Gas Adsorption Properties

(71) Applicant: SK Innovation Co., Ltd., Seoul (KR)

(72) Inventors: Jae Suk CHOI, Daejeon (KR); Seung Woo LEE, Daejeon (KR); Chang Q LEE, Daejeon (KR); Il Gu JUNG, Daejeon (KR)

(21) Appl. No.: 18/922,574

(22) Filed: Oct. 22, 2024

(30) Foreign Application Priority Data
Nov. 3, 2023 (KR) 10-2023-0150424

(51) Int. Cl. H01M 10/52; H01M 4/36; H01M 4/62; H01M 10/052; H01M 50/117; H01M 50/124; H01M 50/434; H01M 50/449

(52) U.S. Cl. CPC H01M 10/52; H01M 4/364; H01M 4/628; H01M 10/052; H01M 50/117; H01M 50/1243; H01M 50/434; H01M 50/449

(57) ABSTRACT

A secondary battery comprises an electrode comprising a cathode comprising a cathode current collector and a cathode mixture layer on at least one surface of the cathode current collector, and an anode comprising an anode current collector and an anode mixture layer on at least one surface of the anode current collector, and a porous substrate separator, and a battery case comprising the electrode assembly and an electrolyte, wherein at least one of the cathode mixture layer, the anode mixture layer, the separator, and an internal surface of the battery case comprises zeolite, and wherein the zeolite has a ratio of liquid-phase adsorption capacity to gas-phase adsorption capacity of about 0.5 to about 1.5.

### CROSS-REFERENCE TO RELATED APPLICATION(S)

This patent document claims the priority and benefit of Korean Patent Application No. 10-2023-0150424 filed on Nov. 3, 2023, the disclosure of which is incorporated herein by reference in its entirety.

### TECHNICAL FIELD

The disclosure and implementations disclosed in this patent document generally relate to a secondary battery having excellent characteristics in reducing the generation of gas inside the secondary battery.

### BACKGROUND

Recently, secondary batteries have been applied to electric vehicles, etc., and as a result, secondary batteries have gradually become larger and larger in capacity. In addition, securing the safety of secondary batteries has become a very important factor in terms of the safety of electric vehicles equipped with secondary batteries.

Secondary batteries may experience forced internal short circuits due to external impacts, etc., which may lead to a risk of battery ignition. In order to solve the problem of battery ignition, inorganic particles, such as boehmite, or a ceramic layer including inorganic particles and organic particles, may be introduced on a separator formed from a porous sheet, such as polyolefin, to suppress shrinkage of the separator due to long-term battery use. In this way, an initial shape may be maintained, thereby suppressing short circuits of secondary batteries and preventing explosions to secure the safety of batteries.

In another aspect, the electrolyte of secondary batteries may decompose due to various reasons over long-term use of the battery, and gas components, such as methane, ethane, carbon monoxide, and carbon dioxide, accumulate inside batteries as decomposition products, causing batteries to swell. Such swollen batteries may be easily damaged by internal and external impacts, which may cause secondary batteries to ignite, explode, etc., and thus have a significant impact on the safety of the secondary batteries.

### SUMMARY

The present disclosure may be implemented in some embodiments to provide a secondary battery having excellent characteristics for removing gas generated inside the secondary battery.

In some embodiments of the present disclosure, a secondary battery comprises an electrode assembly comprising: a cathode comprising a cathode current collector and a cathode mixture layer on at least one surface of the cathode current collector; an anode comprising an anode current collector and an anode mixture layer on at least one surface of the anode current collector; and a porous substrate separator; and a battery case comprising: the electrode assembly and an electrolyte, wherein at least one of the cathode mixture layer, the anode mixture layer, the separator, and an internal surface of the battery case comprises zeolite, and wherein the zeolite has a ratio of liquid-phase adsorption capacity to gas-phase adsorption capacity of about 0.5 to about 1.5.

In one embodiment, the liquid phase adsorption capacity of the zeolite is 3 mmol/g or more.

In one embodiment, the zeolite has pores with a size of about 4.5 Å to about 5.5 Å.

In one embodiment, the separator comprises an adsorption layer on at least one surface of the porous substrate, wherein the adsorption layer comprises inorganic particles and the zeolite.

Additionally or alternatively, in one embodiment, an internal surface of the battery case may comprise an adsorption layer, wherein the adsorption layer comprises inorganic particles and zeolite.

In one embodiment, the adsorption layer further comprises boehmite.

In one embodiment, the boehmite has an average particle size of about 0.01 μm to about 3 μm.

In one embodiment, the adsorption layer comprises about 20 wt % to about 80 wt % of zeolite and about 20 wt % to about 80 wt % of boehmite based on a total weight of zeolite and boehmite.

In one embodiment, the adsorption layer comprises a binder.

In one embodiment, the adsorption layer comprises about 2 wt % to about 10 wt % of binder based on a total weight of the adsorption layer.

In one embodiment, the adsorption layer has a thickness of about 0.3 μm to about 10 μm.

### BRIEF DESCRIPTION OF DRAWINGS

Certain aspects, features, and advantages of the present disclosure are illustrated by the following detailed description with reference to the accompanying drawings.

FIG. 1 is a schematic diagram illustrating a structure of a zeolite included in an embodiment of the present disclosure.

FIG. 2 is an exemplary diagram of a secondary battery according to the present disclosure wherein an adsorptive layer is incorporated on a surface of a battery case.

FIG. 3 is another exemplary diagram of a secondary battery according to the present disclosure wherein an adsorptive layer is incorporated onto surfaces of a separator.

FIG. 4 is another exemplary diagram of a secondary battery according to the present disclosure wherein an adsorptive material is dispersed within one or both of the anode and cathode mixture layers.

FIG. 5 is a graph measuring equilibrium pressure of Example 1 and Comparative Examples 1 to 6.

FIG. 6 is a graph measuring a gas phase adsorption capacity of Example 1 and Comparative Examples 1 to 6.

FIG. 7 is a graph comparing a gas phase adsorption capacity and a liquid phase adsorption capacity of Example 1 and Comparative Examples 1 to 6.

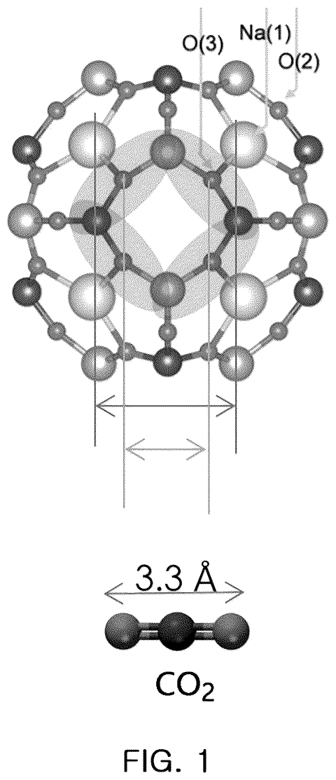

### DETAILED DESCRIPTION

Hereinafter, embodiments will be described with reference to various embodiments. However, the embodiments are not limited to the embodiments described below and may be modified in various other forms.

Use of the term “about” herein refers to the nominal value plus or minus 5% of that nominal value. For example, “about 100” refers to a value of 95 to 105.

In one aspect, provided herein is a secondary battery that effectively adsorbs gas generated inside a secondary battery, wherein the secondary battery comprises a zeolite in which the ratio of the liquid phase adsorption capacity and the gas phase adsorption capacity is appropriately and precisely controlled to impart the desired characteristics, e.g., gas adsorption.

In certain embodiments, a secondary battery may include a gas adsorbent capable of adsorbing a gas generated during an operation of the battery, for example, by incorporating the adsorbent into a component of the secondary battery. Specifically, at least one of the cathode mixture layer, the anode mixture layer, the separator, and the internal surface of the battery case may include a gas adsorbent, e.g., zeolite particles, which displays gas adsorption capacity. In one embodiment, the secondary battery comprises an electrode assembly, the electrode assembly comprising: a cathode comprising a cathode current collector and a cathode mixture layer on at least one surface of the cathode current collector; (2) an anode comprising an anode current collector and an anode mixture layer on at least one surface of the anode current collector; and (3) a porous substrate separator; and a battery case comprising the electrode assembly and an electrolyte, wherein at least one of the cathode mixture layer, the anode mixture layer, the separator, and an internal surface of the battery case comprises zeolite. In certain embodiments, the zeolite may have a ratio of liquid-phase adsorption capacity to gas-phase adsorption capacity of about 0.5 to about 1.5.

When a secondary battery is used for a long time, non-aqueous electrolyte included in the battery may decompose, generating gas components, such as methane, ethane, ethene, hydrocarbons having 3 to 4 carbon atoms, carbon monoxide, and/or carbon dioxide. These gas components may cause an increase in internal pressure of the battery case, thereby deteriorating the safety of the battery.

By including a zeolite according to any embodiment of the present disclosure, gas components generated in the battery case may be adsorbed, thereby preventing the internal pressure of the battery case from excessively increasing. As such, safety of the secondary battery is improved and provides an extended long-term lifespan of the secondary battery.

In certain embodiments, the zeolite has a liquid phase adsorption capacity of 3 mmol/g or more, such as 3 mmol/g to 10 mmol/g. In certain embodiments, the zeolite has a liquid phase adsorption capacity of 5 mmol/g or more, such as 5 mmol/g to 10 mmol/g. In certain embodiments, the zeolite has a liquid phase adsorption capacity of about 4 mmol/g to about 6 mmol/g. In certain embodiments, the zeolite has a liquid phase adsorption capacity of about 5 mmol/g to about 6 mmol/g.

In certain embodiments, the zeolite has a gas phase adsorption capacity of 2 mmol/g or more, such as 2 mmol/g to 10 mmol/g. In certain embodiments, the zeolite has a gas phase adsorption capacity of 3 mmol/g or more, such as 3 mmol/g to 10 mmol/g. In certain embodiments, the zeolite has a gas phase adsorption capacity of 5 mmol/g or more, such as 5 mmol/g to 10 mmol/g.

In certain embodiments, for example, the zeolite may have a ratio of liquid-phase adsorption capacity to gas-phase adsorption capacity of about 0.5 to about 0.75, about 0.5 to about 1, about 0.5 to about 1.25, about 0.75 to about 1.5, about 0.75 to about 1.25, about 0.75 to about 1, about 1 to about 1.5, about 1 to about 1.25, or about 1.25 to about 1.15. In certain embodiments, for example, the zeolite may have a ratio of liquid-phase adsorption capacity to gas-phase adsorption capacity of about 0.5, 0.75, 1, 1.25, or about 1.5.

In certain embodiments, the zeolite has a ratio of gas phase adsorption capacity to liquid phase adsorption capacity for carbon dioxide of about 1:0.5 to about 1:2, specifically about 1:0.67 to about 1:1.7, and more specifically about 1:1. Without wishing to be bound by theory, it is believed that if the ratio of gas phase adsorption capacity to liquid phase adsorption capacity for carbon dioxide is less than 1:0.5, it may be difficult to implement sufficient performance in an actual battery due to a decrease in adsorption capacity caused by interference of the electrolyte. Similarly, it is believed that if the ratio of gas phase adsorption capacity to liquid phase adsorption capacity for carbon dioxide exceeds 1:1.5, the absolute value of the adsorption amount may be low, which may result in poor commerciality. By precisely controlling the liquid phase and gas phase absorption capacity as well as the ratio thereof, a secondary battery with excellent safety performance and reduced risk of explosion may be produced.

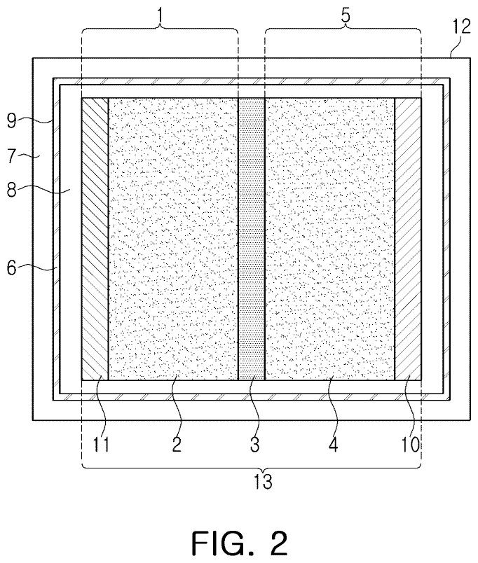

FIG. 2 depicts an exemplary diagram of a secondary battery 12 comprising a cathode 1 comprising a cathode current collector 11 and cathode mixture layer 2 on at least one surface of the cathode current collector 11. The secondary battery 12 further comprises an anode 5 comprising an anode current collector 10 and an anode mixture layer 4 on at least one surface of the anode current collector 10. Between the cathode mixture layer 2 and the anode mixture layer 4 is a porous separator 3. The cathode 1 and the anode 5 are alternately stacked with the separator 2 interposed therebetween to create an electrode assembly 13 and inserted into a battery case 7 with electrolyte 8 and subsequently sealed. An internal surface of the battery case 9 comprises an adsorption layer 6.

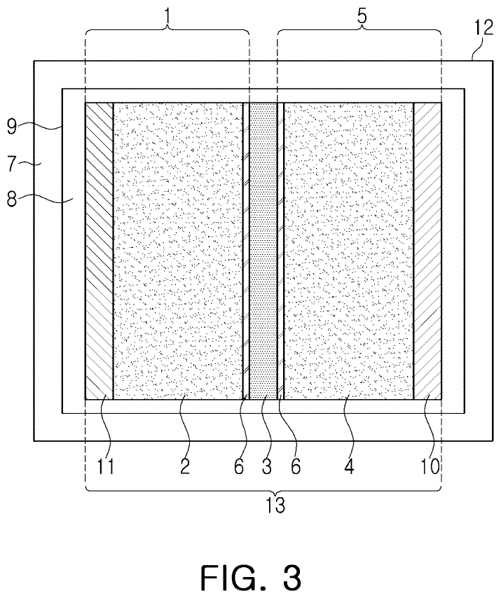

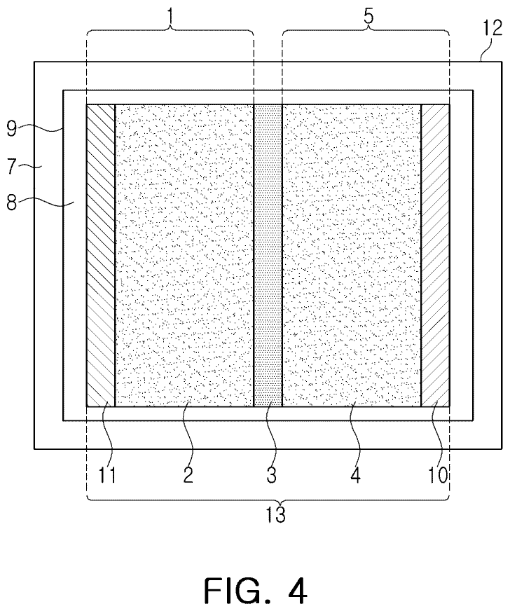

In FIG. 3 (wherein like numbers represent like elements), the secondary battery 12 comprises an adsorption layer 6 two surfaces of the separator 3. In certain embodiments, however, a secondary battery may comprise an adsorption layer 6 on only one surface of the separator. In yet further embodiments, such as shown in FIG. 4 (wherein like numbers represent like elements), an adsorption layer (or absorptive material) is dispersed into one or both of the cathode mixture layer 2 and the anode mixture layer 4.

The structure of the zeolite may be in the form of MFI, CHA, CHA-Cs, CHI, ERI, FAU, FER, GOO, HEU, LTA, MER, MON, MOR, RHO, AEI, AFX, DDR, LEV, RTH, etc., and specifically, it may be in the form of MRE, MFI, CHA, LTA, and FAU, and more specifically, may be in the form of Molecular Sieve 5A, which is one of the forms in which the pore size is adjusted through ion exchange of calcium (Ca) for some portion of sodium (Na) in LTA. A zeolite having any of the aforementioned above structures may have excellent liquid phase adsorption capacity as well as gas phase adsorption capacity.

In certain embodiments, the zeolite may have an average pore size of about 4.5 Å to about 5.5 Å. Without wishing to be bound by theory, it is believed that if the pore size of the zeolite is less than 4.5 Å, gas adsorption may be insufficient. Similarly, it is believed that if the pore size exceeds 5.5 Å, the zeolite may competitively adsorb gas and electrolyte components, resulting in a decrease in adsorption capacity. Measuring pore size of zeolite may be performed by any method known to one of skill in the art, such as BET analysis.

In certain embodiments, the zeolite may have an average particle size of about 4 μm or less, specifically, about 0.1 μm to about 4 μm. Without wishing to be bound by theory, it is believed that if the average particle size of the zeolite exceeds 4 μm, coating may be insufficient and the zeolite may easily fall off from an adherent. Methods for measuring average particles size are well known to those skilled in the art. For example, a Laser Scattering Particle Size Distribution Analyzer can be used. In certain embodiments, the zeolite has a particle size of about 0.75 μm to about 1.25 μm, or about 1 μm.

Hereinafter, a specific example of applying the zeolite will be described.

In one embodiment, the separator comprises a porous substrate and an adsorption layer on at least one surface of or dispersed within the porous substrate, wherein the adsorption layer comprises a zeolite. In one embodiment, the separator comprises a porous substrate and an adsorption layer on one surface of the porous substrate. In one embodiment, the separator comprises a porous substrate and an adsorption layer on two surfaces of the porous substrate, such as shown in FIG. 3. In one embodiment, the separator comprises a porous substrate and an adsorption layer dispersed therein.

The term “absorptive layer” is used herein to refer to an adsorptive material that is either applied onto a surface (e.g., of the separator or internal surface of the battery case) or dispersed within a material, such as the porous material of the separator or the cathode or anode mixture layer. Accordingly, the adsorptive material need not take the form of a discreet “layer,” such as in embodiments wherein the adsorption layer is dispersed within a material.

The separator may be interposed between the cathode and the anode, which will be described below. The thickness of the separator is not particularly limited and may be configured to be any thickness sufficient to prevent electrical short-circuiting between the cathode and the anode and to allow ion flow. In one embodiment, the separator may have a thickness of about 5 μm to about 100 μm but is not limited thereto. Without wishing to be bound by theory, it is believed that if the thickness of the separator on which the adsorption layer is formed is less than 5 μm, there may be insufficient heat resistance. Likewise, if the thickness of the separator exceeds 100 μm, battery performance may be reduced. In one embodiment, the thickness of the separator may be about 10 μm to about 20 μm.

In one embodiment, porous substrate of the separator may include a porous polymer film or a porous nonwoven fabric. The porous polymer film may include one or more of a polyolefin polymer, such as an ethylene polymer, a propylene polymer, an ethylene/butene copolymer, an ethylene/hexene copolymer, and an ethylene/methacrylate copolymer. The porous nonwoven fabric may include one or more of high-melting point glass fibers, polyethylene terephthalate fibers, or the like. In certain embodiments, the separator may also include a ceramic material. For example, inorganic particles, e.g., comprising zeolite and a ceramic material, may be coated on the polymer film, or dispersed within the polymer film to improve heat resistance.

The separator may have a single-layer or multilayer structure, either of which include the polymer film and/or nonwoven fabric described above.

The secondary batteries disclosed herein comprise at least one adsorption layer to adsorbs a gaseous or liquid substance generated within the secondary battery. In certain embodiments, the adsorption layer may further include a binder together with the zeolite. In certain embodiments, the adsorption layer comprises zeolite, an inorganic material, and a binder. The binder may be a polymer-based organic binder, and non-limiting examples thereof include polyvinylidene fluoride-cohexafluoropropylene, polyvinylidene fluoride-cotrichloroethylene, polymethylmethacrylate, polybutylacrylate, polyacrylonitrile, polyvinylpyrrolidone, polyvinylacetate, polyethylene-co-vinyl acetate, polyethylene oxide, polyarylate, cellulose acetate, cellulose acetate butyrate, cellulose acetate propionate, cyanoethylpullulan, cyanoethylpolyvinylalcohol, cyanoethylcellulose, cyanoethylsucrose, pullulan, carboxyl methyl cellulose, amide copolymers, etc.

The adsorption layer may be manufactured by preparing a slurry by mixing and dispersing inorganic particles and a binder in a solvent, applying the prepared slurry to at least one surface of the separator, and drying the same.

In one embodiment, the slurry may include about 90 wt % to about 98 wt % of the inorganic particles and about 2 wt % to about 10 wt % of the binder. Without wishing to be bound by theory, it is believed that if the content of the binder in the slurry is less than 2 wt %, adhesion of the adsorption layer to, e.g., the separator or battery case, may be reduced. Likewise, it is believed that if the content of the binder exceeds 10 wt % and an excessive amount of binder is included, the air permeability of the adsorption layer may be reduced.

In certain embodiments, the inorganic particles may also include boehmite together with zeolite. Advantageously, if the adsorption layer includes boehmite, short-circuiting due to shrinkage of the separator may be prevented and air permeability may be improved.

The boehmite may have an average particle diameter of about 0.01 μm to about 3 μm. Without wishing to be bound by theory, it is believed that if the average particle size of the boehmite is less than 0.01 μm, the air permeability may be excessively high. Likewise, it is believed that if the average particle size exceeds 3 μm, the adhesive strength may be low.

The boehmite may be included in the inorganic particles at a content of about 20 wt % to about 80 wt % of the total weight of the inorganic particles. Without wishing to be bound by theory, it is believed that if boehmite is include but the content of the boehmite is less than 20 wt %, the moisture content may increase, and further, compatibility of the coating slurry with the separator may decrease, resulting in poor coating properties. Likewise, it is believed that if the content of the boehmite exceeds 80 wt %, the zeolite content may be insufficient to impart a gas reduction effect.

The solvent used to create the slurry may be one or a mixture of solvents selected from the group consisting of, but not limited to, water, ethanol, lower alcohols (such as methanol or propanol), dimethylformamide, acetone, tetrahydrofuran, diethyl ether, methylene chloride, DMF, N-methyl-2-pyrrolidone, hexane, and cyclohexane, and more specifically, water may be used.

In this manner, by forming an adsorption layer including boehmite together with zeolite, which has excellent gas adsorption properties, on the surface of a separator, it is possible to prevent shrinkage/expansion of the separator due to heat, while adsorbing and removing gas occurring inside the battery, thereby suppressing expansion of the secondary battery, and improving safety.

In certain embodiments, the adsorption layer may be formed to have a thickness of about 0.3 μm to about 10 μm. Without wishing to be bound by theory, it is believed that if the thickness of the adsorption layer is less than 0.3 μm, the gas reduction effect may be insufficient. Likewise, it is believed that if the thickness of the adsorption layer exceeds 10 μm, packing density per module may be reduced, which may reduce battery capacity and lower battery performance.

As another embodiment, a gas adsorption layer including the zeolite may be formed in a space between the battery case and the electrode assembly.

The battery case may be a pouch-type battery case in which a resin film is laminated on both sides of a metal film and may be a square or cylindrical metal case.

The position in which the adsorption layer is formed is not particularly limited. In certain embodiments, the adsorption layer is formed facing to an electrode surface of the electrode assembly. For example, in an embodiment wherein the adsorption layer is formed on a pouch-type battery case, the adsorption layer may be formed on an internal surface of the battery case facing an electrode surface of the electrode assembly. In such embodiments, the adsorption layer may not be formed adjacent to or in close proximity to where the battery case is sealed. In certain embodiments, the internal surface of the battery case may refer to a portion of the battery case in which the electrode assembly and the battery case are in contact with each other.

The adsorption layer may be formed by mixing and dispersing inorganic particles including zeolite and a binder in a solvent to prepare a slurry, applying the slurry to an internal surface of the battery case, and drying the slurry. The binder and the solvent may be the same as the binder and the solvent according to any embodiment described herein. Likewise, the content of the inorganic particles and binder in the slurry may be as according to any embodiment described herein.

The inorganic particles may also include boehmite together with zeolite. By including boehmite in the adsorption layer on a surface of the battery case, air permeability may be provided to allow diffusion and effective gas adsorption by the zeolite.

As described above for the case of forming the adsorption layer on the separator, the boehmite may have an average particle size of about 0.01 μm to 3 μm.

The boehmite may be included in the organic particles in an amount of about 20 wt % to about 80 wt % based on the total weight of the inorganic particles. Without wishing to be bound by theory, it is believed that if boehmite is include but the content of the boehmite is less than 20 wt %, the compatibility of a coating slurry may be reduced, resulting in poor coating performance, and if the boehmite content exceeds 80 wt %, it is believed that the gas adsorption performance of the adsorption layer may be reduced.

The thickness of the absorption layer on the internal surface of the battery is not particularly limited. For example, in one embodiment, the adsorption layer formed on the internal surface of the battery case may have a thickness of about 0.3 μm or more, such as about 0.3 μm to about 10 μm. Without wishing to be bound by theory, it is believed that if the thickness of the adsorption layer is less than 0.3 μm, the gas adsorption performance by the gas adsorbent may not be sufficient. Meanwhile, it is believed that if the thickness of the adsorption layer formed on the internal surface of the battery case is excessively thick, the battery capacity may be relatively reduced, and thus, the thickness of the absorption layer may be about 10 μm or less.

As another embodiment, zeolite as a gas adsorbent may be included in the electrode, and specifically, in an electrode mixture layer on an electrode current collector. The electrode may refer to a positive electrode (i.e., a cathode) and/or a negative electrode (i.e., an anode), and the electrode mixture layer may refer to a cathode mixture layer and/or an anode mixture layer.

As shown in FIGS. 2-4, the cathode 1 may include a cathode current collector 11 and a cathode mixture layer 2 on at least one surface of the cathode current collector 11.

The cathode current collector may comprise stainless steel, nickel, aluminum, titanium, or alloys thereof. The cathode current collector may also include aluminum or stainless steel surface-treated with carbon, nickel, titanium, or silver. The cathode current collector may have, but is not limited to, a thickness of, for example, 10 μm to 50 μm.

The cathode mixture layer may include a cathode active material. The cathode active material may include a compound capable of reversibly intercalating and deintercalating lithium ions.

In certain embodiments, the cathode active material may include a lithium-nickel metal oxide. The lithium-nickel metal oxide may further include at least one of cobalt (Co), manganese (Mn), and aluminum (Al).

In some embodiments, the cathode active material or the lithium-nickel metal oxide may include a layered structure, or a crystal structure represented by Chemical Formula 1 below.

LiₓNiₐM_{b}O_{2+z} [Chemical Formula 1]

In Chemical Formula 1, 0.9≤x≤1.2, 0.6≤a≤0.99, 0.01≤b≤0.4, and −0.5≤z≤0.1 may be satisfied. As described above, M may include Co, Mn, and/or Al.

The chemical structure represented by Chemical Formula 1 represents a bonding relationship included in the layered structure or crystal structure of the cathode active material and does not exclude other additional elements. For example, M may include Co and/or Mn, and Co and/or Mn may serve as main active elements of the cathode active material together with Ni. Chemical Formula 1 is provided to express the bonding relationship of the main active elements and should be understood as a formula encompassing the introduction and substitution of additional elements.

In certain embodiments, the cathode active material may further comprise one or more auxiliary elements to enhance the chemical stability of the cathode active material or the layered structure/crystal structure. The auxiliary element may be incorporated into the layered structure/crystal structure to form a bond, and also, in this case, it should be understood that the auxiliary element is also included within the chemical structure range represented by Chemical Formula 1.

The auxiliary element may include, for example, at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, and Zr. The auxiliary element may also act as an auxiliary active element that contributes to the capacity/output activity of the cathode active material together with Co or Mn, like Al.

In one example, the cathode active material or the lithium-nickel metal oxide may include a layered structure or crystal structure represented by Chemical Formula 1-1 below.

LiₓNiₐM1_{b1}M2_{b2}O_{2+z} [Chemical Formula 1-1]

In Chemical Formula 1-1, M1 may include Co, Mn, and/or Al. M2 may include the auxiliary elements described above. In Chemical Formula 1-1, 0.9≤x≤1.2, 0.6≤a≤0.99, 0.01≤b1+b2≤0.4, and −0.5≤z≤0.1 may be satisfied.

The cathode active material may further include a coating element or a doping element. For example, elements substantially identical to or similar to the auxiliary elements described above may be used as the coating element or the doping element. The elements described above may be used alone or in combination of two or more as the coating element or the doping element.

The coating element or the doping element may be present on the surface of the lithium-nickel metal oxide particle or may penetrate through the surface of the lithium-nickel metal composite oxide particle to be included in the bonding structure represented by Chemical Formula 1 or Chemical Formula 1-1.

The cathode active material may include a nickel-cobalt-manganese (NCM)-based lithium oxide. In certain embodiments, an NCM-based lithium oxide with an increased nickel content may be used.

Ni may be provided as a transition metal associated with the output and capacity of a lithium secondary battery. Therefore, as described above, by employing a high-content (high-Ni) composition in the cathode active material, a high-capacity cathode and a high-capacity lithium secondary battery may be provided.

However, as the Ni content increases, the long-term storage stability and life stability of the cathode or secondary battery may be relatively reduced, and side reactions with the electrolyte may also increase. However, in certain embodiments, electrical conductivity can be maintained by including Co, and life stability and capacity retention characteristics may be improved by including Mn.

The content of Ni in the NCM-based lithium oxide (for example, a mole fraction of nickel in the total moles of nickel, cobalt, and manganese) may be about 0.6 or more, about 0.7 or more, or about 0.8 or more. In some embodiments, the Ni content may be about 0.8 to about 0.95, about 0.82 to about 0.95, about 0.83 to about 0.95, about 0.84 to about 0.95, about 0.85 to about 0.95, or about 0.88 to about 0.95.

In some embodiments, the cathode active material may include a lithium cobalt oxide-based active material, a lithium manganese oxide-based active material, a lithium nickel oxide-based active material, or a lithium iron phosphate (LFP)-based active material (e.g., LiFePO₄).

In some embodiments, the cathode active material may include a Mn-rich active material, a Li-rich layered oxide (LLO)/over lithiated oxide (OLO)-based active material, or a Co-less active material having a chemical structure or crystal structure represented by Chemical Formula 2, for example.

p[Li₂MnO₃]·(1−p)[Li_{q}JO₂] [Chemical Formula 2]

In Chemical Formula 2, 0<p<1, 0.9≤q≤1.2, and J may include at least one element selected from the group consisting of Mn, Ni, Co, Fe, Cr, V, Cu, Zn, Ti, Al, Mg, and B.

A cathode slurry may be prepared by mixing the cathode active material in a solvent. After coating the cathode slurry on the cathode current collector, the cathode current collector may be dried and rolled to manufacture a cathode mixture layer. The coating process may be performed by any known method, such as gravure coating, slot die coating, multilayer simultaneous die coating, imprinting, doctor blade coating, dip coating, bar coating, casting, etc., but is not limited thereto. The cathode mixture layer may further include a binder and optionally may further include a conductive agent, a thickener, etc.

Non-limiting examples of solvents that may be used in the preparation of the above-mentioned cathode mixture may include N-methyl-2-pyrrolidone (NMP), dimethylformamide, dimethylacetamide, N,N-dimethylaminopropylamine, ethylene oxide, tetrahydrofuran, etc. The binder may comprise one or more of polyvinylidene fluoride (PVDF), vinylidene fluoride-co-hexafluoropropylene copolymer, polyacrylonitrile, polymethylmethacrylate, acrylonitrile butadiene rubber (NBR), polybutadiene rubber (BR), styrene-butadiene rubber (SBR), etc. In an embodiment, a PVDF series binder may be used as the cathode binder.

A conductive agent may be added to enhance the conductivity of the cathode mixture layer and/or the mobility of lithium ions or electrons. For example, the conductive agent may be a carbon series conductive agent, such as graphite, carbon black, acetylene black, Ketjen black, graphene, carbon nanotubes, vapor-grown carbon fiber (VGCF), carbon fiber, etc., and/or a metal series conductive material including perovskite materials, such as tin, tin oxide, titanium oxide, LaSrCoO₃, and LaSrMnO₃, but the present disclosure is not limited thereto.

If necessary, the cathode mixture may further include a thickener and/or a dispersant. In an embodiment, the cathode mixture layer may include a thickener, such as carboxymethyl cellulose (CMC).

As shown in FIGS. 2-4, the anode 5 may include an anode current collector 10 and an anode mixture layer 4 on at least one surface of the anode current collector 10.

The anode current collector may comprise copper foil, nickel foil, stainless steel foil, titanium foil, nickel foam, copper foam, a polymer substrate coated with a conductive metal, etc. The anode current collector may have, but is not limited to, a thickness of about 10 μm to about 50 μm.

The anode mixture layer may include an anode active material. The anode active material may include a material capable of adsorbing and desorbing lithium ions.

For example, the anode active material may comprise a carbon-based material, such as crystalline carbon, amorphous carbon, a carbon composite, or carbon fiber; lithium metal; a lithium alloy; a silicon (Si)-containing material or a tin (Sn)-containing material, etc.

Non-limiting examples of amorphous carbon include hard carbon, soft carbon, coke, mesocarbon microbead (MCMB), mesophase pitch-based carbon fiber (MPCF), etc.

Non-limiting examples of crystalline carbon may include graphite-based carbon, such as natural graphite, artificial graphite, graphitized coke, graphitized MCMB, and graphitized MPCF.

The lithium metal may include pure lithium metal or lithium metal having a protective layer formed thereon, e.g., for suppressing dendrite growth. In an embodiment, a lithium metal-containing layer deposited or coated on the anode current collector may be used as an anode active material layer. In an embodiment, a lithium thin film layer may be used as the anode active material layer.

Elements that may be included in the lithium alloy include aluminum, zinc, bismuth, cadmium, antimony, silicon, lead, tin, gallium, and/or indium.

In certain embodiments, inclusion of a silicon-containing material may improve capacity characteristics. The silicon-containing material may include Si, SiOₓ (0<x<2), metal-doped SiOₓ (0<x<2), silicon-carbon composite, etc. The metal may include lithium and/or magnesium, and the metal doped SiOₓ (0<x<2) may include the metal silicate.

An anode slurry may be prepared by mixing the anode active material in a solvent. The anode slurry may be coated/deposited on the anode current collector, and then dried and rolled to prepare an anode mixture layer. The coating process may be performed by any known method, such as gravure coating, slot die coating, multilayer simultaneous die coating, imprinting, doctor blade coating, dip coating, bar coating, casting, etc., but is not limited thereto. The anode mixture layer may further include a binder and optionally may further include a conductive agent, a thickener, etc.

In some embodiments, the anode may include an anode active material layer in the form of lithium metal formed through a deposition/coating process.

Non-limiting examples of the solvent for preparing the anode mixture include water, pure water, deionized water, distilled water, ethanol, isopropanol, methanol, acetone, n-propanol, t-butanol, etc.

Any aforementioned materials detailed for use in the manufacture of the cathode may be used in the anode, such as the binder, conductive agent, and thickener.

In some embodiments, the anode binder may include a styrene-butadiene rubber (SBR)-based binder, carboxymethyl cellulose (CMC), a polyacrylic acid-based binder, a poly(3,4-ethylenedioxythiophene, PEDOT)-based binder, etc.

In certain embodiments, zeolite may be included in an amount of about 0.5 wt % to about 10 wt % based on the total weight of the electrode mixture layer. Without wishing to be bound by theory, it is believed that if the content of the zeolite is less than 0.5 wt %, the gas adsorption may be insufficient. It is also believed that if the zeolite content exceeds 10 wt %, the decrease in the relative content of the electrode active material may result in a decrease in battery capacity.

As described above, in each embodiment of the present disclosure, by including zeolite in each component of the battery, the gas component occurring inside the battery due to decomposition of the electrolyte may be effectively adsorbed, thereby suppressing expansion of the battery due to gas occurrence, and thus, the safety of the battery may be improved.

### EXAMPLES

Hereinafter, the present disclosure will be specifically described by way of examples. The following examples describes the gas removal effect by taking as an example a case in which a gas adsorption layer is formed on a separator, but it will be easily understood from the following examples that the same effect may be obtained even when the zeolite of the present disclosure is included in each component of the battery.

### MANUFACTURING EXAMPLE

### 1. Manufacturing of a Sample for Gas Adsorption

### (1) Manufacturing Example 1 (LTA-5A Zeolite)

A commercial LTA zeolite in the form of Molecular Sieve 5A, one of the forms in which the pore size is controlled through ion exchange of Ca for some portion of Na (Vision Chemical Co., Ltd.), was secured, and the particle size was adjusted using a Bead Milling Machine. The average particle diameter was confirmed to be 1 μm using a Laser Scattering Particle Size Distribution Analyzer (LA-950V2, Horiba Co., Ltd.). Thereafter, surface foreign substances and residual moisture were removed through vacuum drying at 300° C. for 6 hours, and then gas and liquid phase adsorption evaluations were conducted.

### (2) Comparative Manufacturing Example 1 (MRE Zeolite)

A sample was prepared in the same manner as in Example 1, except that MRE (Zeolyst Co., Ltd., having a pore size of about 5.6 Å) was used instead of LTA-5A zeolite.

### (3) Comparative Manufacturing Example 2 (MFI Zeolite)

A sample was prepared in the same manner as in Example 1, except that MFI (Zeolyst Co., Ltd. having a pore size of about 4.7 Å) was used instead of LTA-5A zeolite.

### (4) Comparative Manufacturing Example 3 (CHA-Cs Zeolite)

A sample was prepared in the same manner as in Example 1, except that CHA (Heesung Catalyst Co., Ltd, having a pore size of about 3.8 Å) was used by ion-exchanging with Cs, instead of LTA-5A zeolite.

### (5) Comparative Manufacturing Example 4 (CHA Zeolite)

A sample was prepared in the same manner as in Example 1, except that CHA (Heesung Catalyst Co., Ltd, having a pore size of about 3.8 Å) was used instead of LTA-5A zeolite.

### (6) Comparative Manufacturing Example 5 (LTA-4A Zeolite)

A sample was prepared in the same manner as in Example 1, except that LTA-4A (Vision Chemical Co., Ltd., having a pore size of about 4 Å) was used instead of LTA-5A zeolite.

### (7) Comparative Manufacturing Example 6 (FAU Zeolite)

A sample was prepared in the same manner as in Example 1, except that FAU (Sigma Co. Ltd., having a pore size of about 7.4 Å) was used instead of LTA-5A zeolite.

### EVALUATION EXAMPLE

### 1. Measurement of Gas-Phase Adsorption Capacity

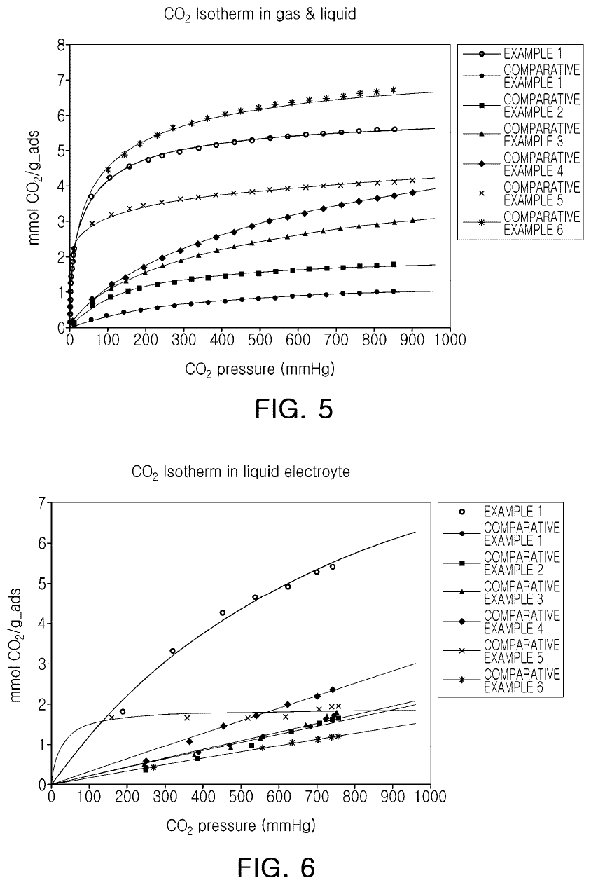

The gas-phase adsorption capacity of each sample was measured by supplying carbon dioxide to a device (ASAP 2020, Micrometics Co. Ltd.) that measures BET surface area through nitrogen adsorption and desorption. After 0.2 g of dried sample was injected into a quartz cell and mounted, CO₂ was injected at 50 mm Hg intervals from 10 mm Hg to 850 mm Hg and equilibrium pressure was measured to calculate the adsorption amount, which is shown in FIG. 5. Whether equilibrium was reached at each stage was determined based on a pressure change rate of 0.1% or less per second at the corresponding pressure.

### 2. Measurement of Liquid (Electrolyte) Adsorption Capacity

0.8-0.9 g of pretreated adsorbent and 12 g of electrolyte (EC/EMC/DEC=3/5/2, Soulbrain) were introduced into an autoclave in a glove box filled with nitrogen.

Nitrogen below 50 kPa was introduced into the autoclave, a leak test was performed for 10 minutes, and then, an internal temperature was raised to 40° C.

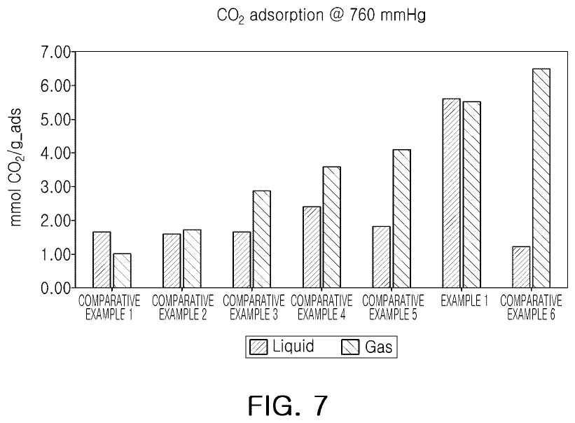

At the internal temperature of 40° C., nitrogen in the autoclave was removed through CO₂ purge, 100 kPa CO₂ was filled into a supply unit, and then injected into the autoclave while stirring. The injected CO₂ was allowed to be dissolved in the electrolyte and be adsorbed on the adsorbent, and pressure when there was no pressure change for more than 5 minutes was considered as equilibrium pressure, and the adsorption amount at that time was measured. This process was repeated until the equilibrium pressure of the autoclave reached 97 kPa or higher, and a liquid phase adsorption capacity was measured, which is shown in FIG. 6. In addition, a graph comparing the gas phase adsorption capacity and liquid phase adsorption capacity described above is shown in FIG. 7.

TABLE 1

| | Liquid phase | Gas phase | Ratio of liquid phase |
|---|---|---|---|
| | adsorption | adsorption | adsorption capacity/gas |
| | capacity | capacity | phase adsorption |
| | (mmol/g) | (mmol/g) | capacity |
| Example 1 | 5.58 | 5.55 | 1.01 |
| Comparative | 1.65 | 0.98 | 1.68 |
| Example 1 | | | |
| Comparative | 1.58 | 1.72 | 0.92 |
| Example 2 | | | |
| Comparative | 1.64 | 2.87 | 0.57 |
| Example 3 | | | |
| Comparative | 2.40 | 3.58 | 0.67 |
| Example 4 | | | |
| Comparative | 1.83 | 4.09 | 0.45 |
| Example 5 | | | |
| Comparative | 1.21 | 6.51 | 0.19 |
| Example 6 | | | |

Referring to Table 1 above, it can be seen that the separator of Example 1 has a ratio of liquid phase adsorption capacity to gas phase adsorption capacity of 1.01 and that the liquid phase adsorption capacity is also excellent.

Meanwhile, it can be seen that the gas phase adsorption capacity of Comparative Examples (CE) 1 and 5 cause these samples to fall outside of the desired ratio of liquid phase adsorption capacity to gas phase adsorption capacity range. This may mean that the zeolite has a low CO₂ adsorption capacity or cannot effectively adsorb gas occurring inside the secondary battery. The gas phase absorption capacity of Comparative Example 6 is superior to the gas phase adsorption capacity of Example 1, but it can be seen that, due to the pore size of the zeolite, the electrolyte easily moves into the zeolite pores and competes for the carbon dioxide adsorption site, so that the liquid phase adsorption capacity is inferior and therefore has a liquid phase adsorption capacity to gas phase adsorption capacity ratio falling outside the desired range.

Comparative Examples 2 to 4 have the ratio of liquid phase adsorption capacity and gas phase adsorption capacity within the desired range, but it can be seen that, the gas phase and liquid phase adsorption capacities are low, so the gas inside the secondary battery cannot be effectively adsorbed.

Only specific examples of implementations of certain embodiments are described. Variations, improvements and enhancements of the disclosed embodiments and other embodiments may be made based on the disclosure of this patent document.

What is claimed is:

1. A secondary battery comprising:
an electrode assembly comprising:
a cathode comprising a cathode current collector and a cathode mixture layer on at least one surface of the cathode current collector;
an anode comprising an anode current collector and an anode mixture layer on at least one surface of the anode current collector; and
a porous substrate separator; and
a battery case comprising:
the electrode assembly and an electrolyte,
wherein at least one of the cathode mixture layer, the anode mixture layer, the separator, and an internal surface of the battery case comprises zeolite, and
wherein the zeolite has a ratio of liquid-phase adsorption capacity to gas-phase adsorption capacity of about 0.5 to about 1.5.

2. The secondary battery of claim 1, wherein the liquid phase adsorption capacity of the zeolite is 3 mmol/g or more.

3. The secondary battery of claim 1, wherein the zeolite has a ratio of liquid-phase adsorption capacity to gas-phase adsorption capacity of about 0.75 to about 1.25.

4. The secondary battery of claim 1, wherein the zeolite pores, each having a size of about 4.5 Å to about 5.5 Å.

5. The secondary battery of claim 1, wherein the zeolite is in the form of Molecular Sieve 5A.

6. The secondary battery of claim 1, wherein the separator comprises an adsorption layer on at least one surface of the porous substrate, and wherein the adsorption layer comprises inorganic particles and the zeolite.

7. The secondary battery of claim 1, wherein an internal surface of the battery case comprises an adsorption layer, and wherein the adsorption layer comprises inorganic particles and the zeolite.

8. The secondary battery of claim 7, wherein the adsorption layer further comprises boehmite.

9. The secondary battery of claim 8, wherein the boehmite has an average particle size of about 0.01 μm to about 3 μm.

10. The secondary battery of claim 8, wherein the adsorption layer comprises about 20 wt % to about 80 wt % of zeolite and about 20 wt % to about 80 wt % of boehmite based on the total weight of zeolite and boehmite.

11. The secondary battery of claim 7, wherein the adsorption layer further comprises a binder.

12. The secondary battery of claim 11, wherein the adsorption layer comprises about 2 wt % to about 10 wt % of the binder based on the total weight of the adsorption layer.

13. The secondary battery of claim 7, wherein the adsorption layer has a thickness of about 0.3 μm to about 10 μm.

14. The secondary battery of claim 6, wherein the adsorption layer further comprises boehmite.

15. The secondary battery of claim 14, wherein the boehmite has an average particle size of about 0.01 μm to about 3 μm.

16. The secondary battery of claim 14, wherein the adsorption layer comprises about 20 wt % to about 80 wt % of zeolite and about 20 wt % to about 80 wt % of boehmite based on the total weight of zeolite and boehmite.

17. The secondary battery of claim 6, wherein the adsorption layer further comprises a binder.

18. The secondary battery of claim 17, wherein the adsorption layer comprises about 2 wt % to about 10 wt % of the binder based on the total weight of the adsorption layer.

19. The secondary battery of claim 6, wherein the adsorption layer has a thickness of about 0.3 μm to about 10 μm.

20. The secondary battery of claim 1, wherein at least one of the cathode mixture layer and the anode mixture layer comprises the zeolite.
